(19) United States
(12) Patent Application Publication
(10) Pub. No.: US 2026/0011932 A1
(43) Pub. Date: Jan. 8, 2026

(54) TERMINAL-EQUIPPED WIRE AND BONDING METHOD THEREOF

(71) Applicant: Yazaki Corporation, Tokyo (JP)

(72) Inventor: Naokazu Nagasaka, Shizuoka (JP)

(73) Assignee: Yazaki Corporation, Tokyo (JP)

(21) Appl. No.: 19/254,283

(22) Filed: Jun. 30, 2025

(30) Foreign Application Priority Data
Jul. 4, 2024 (JP) 2024-107980

(51) Int. Cl. H01R 4/02; H01R 43/02

(52) U.S. Cl. CPC H01R 4/023; H01R 43/0207

(57) ABSTRACT

A terminal-equipped wire includes: a wire having a core wire, and an insulator covering portion that covers the core wire with a part of the core wire exposed; and a terminal having a wire connection portion to which the core wire of the wire is bonded. A concave serration extending along a width direction of the terminal is formed on a conductor bonding surface of the wire connection portion, and the core wire and the terminal are bonded to each other by method of ultrasonic bonding in a state in which the core wire is in contact with the serration. A bonding mark with which a convex portion of a horn of an ultrasonic bonding machine was in contact is formed on a side of the core wire opposite to a side bonded to the terminal.

### CROSS-REFERENCE TO RELATED APPLICATIONS

The present application is based on, and claims priority from the Japanese Patent Application No. 2024-107980, filed on Jul. 4, 2024, the entire contents of which are incorporated herein by reference.

### TECHNICAL FIELD

The present disclosure relates to a terminal-equipped wire and a bonding method thereof.

### BACKGROUND

When a terminal-equipped wire is manufactured in which a terminal is connected to a core wire exposed from a terminal portion of the wire, the core wire and the terminal are integrally connected by method of ultrasonic bonding by pressing the core wire against the terminal and applying ultrasonic vibration (see JP 2023-149552 A). In such a terminal-equipped wire, generally, the core wire exposed from the terminal portion of the wire and a part of the terminal are clamped by an anvil and a horn, and the horn is vibrated with ultrasonic waves to bond the electric core wire to the terminal (ultrasonic bonding).

### SUMMARY OF THE INVENTION

In ultrasonic bonding, the bonding strength between a terminal and an electric core wire depends on the size of the area where the electric core wire comes into contact with the terminal. In the case of JP 2023-149552 A, if the area where the electric core wire comes into contact with the terminal is not sufficiently secured, a problem may arise that the bonding strength cannot be increased.

The present disclosure has been made in view of such a problem in the related art. An object of the present disclosure is to provide a terminal-equipped wire in which a bonding strength between a terminal and an electric core wire is improved by increasing an area where the electric core wire comes into contact with the terminal, and a bonding method thereof.

A terminal-equipped wire according to the present embodiment includes: a wire having a core wire, and an insulator covering portion that covers the core wire with a part of the core wire exposed; and a terminal having a wire connection portion to which the core wire of the wire is bonded, in which a concave serration extending along a width direction of the terminal is formed on a conductor bonding surface of the wire connection portion, the core wire and the terminal are bonded to each other by method of ultrasonic bonding in a state in which the core wire is in contact with the serration, a bonding mark with which a convex portion of a horn of an ultrasonic bonding machine was in contact is formed on a side of the core wire opposite to a side bonded to the terminal, and a center of the serration and a center of the bonding mark are arranged so as to be aligned on a straight line parallel to a height direction of the core wire.

A bonding method of a terminal-equipped wire according to the present embodiment in which a wire having a core wire and an insulator covering portion covering the core wire with a part of the core wire exposed, and a terminal having a wire connection portion to which the core wire of the wire is bonded are clamped by a horn and an anvil of an ultrasonic bonding machine and bonded to each other by method of ultrasonic bonding, in which a concave serration extending along a width direction of the terminal is formed on a conductor bonding surface of the wire connection portion, and a convex portion extending along a width direction of the terminal is formed in the horn. The bonding method includes: a step of arranging the core wire on an upper part of the wire connection portion of the terminal after arranging the terminal on an upper part of the anvil; a step of arranging a center of the serration and a center of the convex portion so as to be aligned on a straight line parallel to a height direction of the core wire; and a step of bringing the horn into contact with the core wire, pressurizing and vibrating the horn in a vertical downward direction in a state in which the core wire is in contact with each of the serration and the convex portion, and bonding the core wire and the terminal by method of ultrasonic bonding. After ultrasonic bonding, a bonding mark with which the convex portion of the horn was in contact is formed on a side of the core wire opposite to a side bonded to the terminal, and a center of the serration and a center of the bonding mark are arranged so as to be aligned on a straight line parallel to a height direction of the core wire.

The present disclosure makes it possible to provide a terminal-equipped wire in which a bonding strength between a terminal and an electric core wire is improved by increasing an area where the electric core wire comes into contact with the terminal, and a bonding method thereof.

### BRIEF DESCRIPTION OF DRAWINGS

FIG. 1 is a perspective view illustrating an example of a terminal-equipped wire according to a present embodiment.

FIG. 2 is a perspective view illustrating a state before a terminal and a wire are bonded.

FIG. 3 is a side view illustrating a state in which the terminal and the wire are arranged in an ultrasonic bonding machine.

FIG. 4 is a side view illustrating a state in which the terminal and the wire are bonded in the ultrasonic bonding machine.

FIG. 5 is an enlarged view of FIG. 4.

FIG. 6 is a cross-sectional view schematically illustrating an enlarged serration formed on a conductor bonding surface of a wire connection portion.

### DETAILED DESCRIPTION OF THE INVENTION

Hereinafter, a terminal-equipped wire and a bonding method thereof according to a present embodiment will be described in detail with reference to the drawings. The dimensional ratios in the drawings are exaggerated for the sake of explanation, and may differ from the actual ratios.

### [Terminal-Equipped Wire]

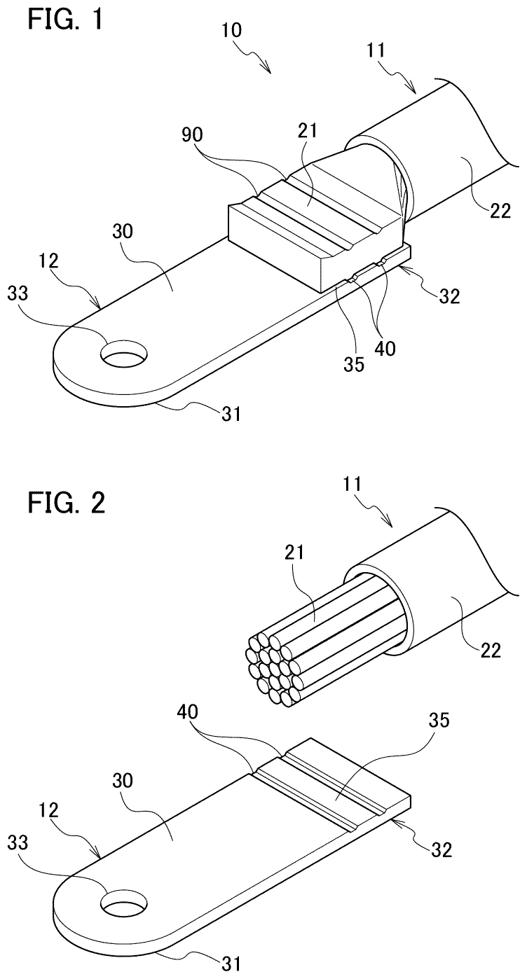

As illustrated in FIG. 1, a terminal-equipped wire 10 includes an wire 11 and a terminal 12 connected to the end of the wire 11. In the present embodiment, the terminal-equipped wire 10 in which the terminal 12 is connected to the end of the wire 11 as a bonding body will be described with an example.

The wire 11 is an insulated wire having a conductor member (core wire 21) formed of a conductive material and an insulator covering portion 22 as an outer skin covering the periphery of the core wire 21. The core wire 21 is formed by bundling a plurality of elementary wires formed of conductive metal materials such as copper, copper alloy, aluminum, aluminum alloy. The material of the conductor member is not limited to copper, copper alloy, aluminum, aluminum alloy or the like, and may be other conductive metal materials. In addition, the structure of the conductor material is not limited to twisted wires formed by twisting a plurality of elementary wires, and may be other forms (single core wire, braided wire, FPC (flexible thin plate wire) or the like).

In the terminal-equipped wire 10, the wire 11 has the core wire 21, and the insulator covering portion 22 that covers the core wire 21 with a part of the core wire 21 exposed. The insulator covering portion 22 is composed of a resin material having flexibility and insulating properties. The material and structure of the insulator covering portion 22 are not particularly limited. At the end of the wire 11, a part of the core wire 21 is exposed by removing the insulator covering portion 22. When the core wire 21 is composed of a plurality of elementary wires formed of copper or a copper alloy, each elementary wire may be plated with tin, nickel, silver, gold, or the like. Further, the type of plating applied to each elementary wire or core wire is not particularly limited.

The terminal 12 is formed by processing a plate material formed of a conductive metal material. In the present embodiment, the terminal 12 is formed by processing a plate material (base material) formed of copper or a copper alloy. The base material of the terminal 12 is not limited to copper or a copper alloy, and may be other conductive metal materials. Further, the base material of the terminal 12 may be plated with tin, nickel, silver, gold, or the like. Furthermore, the type of plating applied to the base material of the terminal 12 is not particularly limited.

The terminal 12 is formed as a flat terminal body 30, and the terminal 12 (terminal body 30) has an electric connection portion 31 and a conductor connection portion (wire connection portion 32). The terminal 12 (terminal body 30) may further have a covering crimping portion (rear foot portion) having a pair of crimping pieces crimped to the insulator covering portion 22 at the end of the wire 11.

The electric connection portion 31 of the terminal 12 has a hole 33 penetrating through the front and rear sides of the terminal body 30. The electric connection portion 31 is fastened and fixed to the connection portion of various devices by inserting a fastening member such as a bolt and a screw into the hole 33, thereby electrically connecting thereto. The shape of the electric connection portion 31 formed at the front end of the terminal 12 is not particularly limited, and may be a male type, a female type, or LA (round type), for example.

The terminal 12 has a wire connection portion 32 to which the core wire 21 of the wire 11 is bonded. One side of the wire connection portion 32 of the terminal 12 is a conductor bonding surface 35, and the core wire 21 of the wire 11 is bonded to the conductor bonding surface 35. The core wire 21 of the wire 11 is bonded to the conductor bonding surface 35 of the wire connection portion 32 by method of ultrasonic bonding. Thus, the terminal 12, and the core wire 21 of the wire 11 are electrically connected to each other.

The terminal-equipped wire 10 may be provided with an exterior member such as a heat-shrinkable tube, a resin material, or a sheet, which is externally mounted on the bonding portion (wire connection portion 32) between the terminal 12 and the core wire 21 of the wire 11 for the purpose of waterproofing and corrosion prevention.

In the present embodiment, although one wire 11 is bonded to the terminal 12, a plurality of wires may be bonded together like a joint terminal. When a plurality of wires are bonded together, for example, the present embodiment can be applied to a bus bar. That is, the terminal 12 may have a plurality of conductor connection portions (wire connection portions 32).

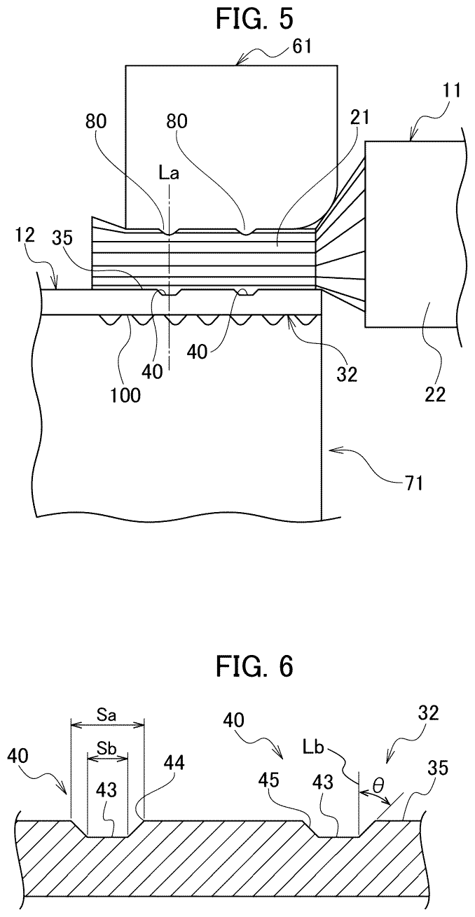

As illustrated in FIGS. 1 to 5, a concave serration 40 (in the present embodiment, two serrations 40) extending along the width direction of the terminal 12 (direction perpendicular to the longitudinal direction) is formed on the conductor bonding surface 35 of the wire connection portion 32 to which the core wire 21 of the wire 11 is bonded. As illustrated in FIG. 5, at the time of ultrasonic bonding, the serration 40 of the conductor bonding surface 35 and the convex portion 80 of the horn 61 of the ultrasonic bonding machine are arranged so as to be aligned on a straight line La parallel to the height direction of the core wire 21. For this reason, at the time of ultrasonic bonding, the portion of the core wire 21 that is locally pressed in the vertical downward direction by the convex portion 80 of the horn 61 is pushed more strongly to the wire connection portion 32 than the other portions of the core wire 21, and plastically flows, thereby reaching the inner side of the serration 40 of the wire connection portion 32. This makes it possible to increase the area where the core wire 21 comes into contact with the wire connection portion 32 as compared to the shape without the serration 40. Therefore, it is possible to manufacture the terminal-equipped wire 10 in which the bonding strength between the terminal 12 and the core wire 21 is improved.

From the viewpoint of increasing the area where the core wire 21 comes into contact with the wire connection portion 32, it is preferable that the length of the serration 40 be at least equal to the length of the convex portion 80 of the horn 61. Further, as illustrated in FIG. 2, it is preferable that the serration 40 extends over the entire width direction of the terminal 12 in the conductor bonding surface 35.

In the terminal-equipped wire 10, in a state in which the core wire 21 is in contact with the serration 40, the core wire 21 and the terminal 12 are bonded to each other by method of ultrasonic bonding. Meanwhile, as illustrated in FIG. 1, a bonding mark 90 with which the convex portion 80 of the horn 61 of the ultrasonic bonding machine was in contact is formed on the side of the core wire 21 opposite to the side bonded to the terminal 12 (conductor bonding surface 35). As described above, the serration 40 of the conductor bonding surface 35 and the convex portion 80 of the horn 61 are ultrasonically bonded in a state where they are arranged so as to be aligned on the straight line La parallel to the height direction of the core wire 21. Therefore, the center of the serration 40 of the wire connection portion 32 and the center of the bonding mark 90 are arranged so as to be aligned on the straight line La parallel to the height direction of the core wire 21.

FIG. 6 illustrates an example of the serration 40 and illustrates an enlarged view of the serration 40 formed on the conductor bonding surface 35 of the wire connection portion 32. The serration 40 is formed into a concave shape having a bottom surface 43 and a side surface 45, and is opened at an opening 44. From the viewpoint of increasing the area where the core wire 21 comes into contact with the conductor bonding surface 35, it is preferable that the width Sa of the opening 44 of the serration 40 is larger than the width Sb of the bottom surface 43 of the serration 40. In the serration 40, the angle θ of the side surface 45 with respect to the normal Lb of the bottom surface 43, that is, the angle θ of the side surface 45 with respect to the depth direction of the serration 40, is preferably greater than 0°, and more preferably 45° or more to 75° or less. By setting the angle θ of the side surface 45 with respect to the normal Lb of the bottom surface 43 to 45° or more, the area where the core wire 21 comes into contact with the wire connection portion 32 can be effectively increased. Note that the shape of the serration 40 is not limited thereto, and for example, the cross-sectional shape may be formed into a rectangular shape, a triangular shape, or an arcuate shape.

The depth of the serration 40 is not particularly limited. For example, it is higher than the surface roughness of the conductor bonding surface 35 of the terminal 12 and lower than the diameter (height) of the core wire 21. The width of the serration 40 is not particularly limited. The shapes of the respective serrations 40 may be the same or different. In addition, the number of serrations 40 is not particularly limited.

The manufacturing method (molding method) of the serration 40 is not particularly limited. The serration 40 may be formed, for example, when the terminal 12 (terminal body 30) is subjected to press working (punching, bending, etc.) using a mold.

The horn 61 of the ultrasonic bonding machine is provided with the convex portion 80 extending along the width direction of the terminal 12. The height, width and length of the convex portion 80 are not particularly limited. Further, the shape of the convex portion 80 is not particularly limited, and the cross-sectional shape may be formed into a rectangular shape, a triangular shape, or an arcuate shape. The shape of the respective convex portions 80 may be the same or different. In addition, although the number of the convex portions 80 is not particularly limited, it is preferable that the number of the convex portions 80 be the same as the number of the serrations 40.

The manufacturing method (molding method) of the convex portion 80 is not particularly limited. The convex portions 80 may be formed, for example, when the horn 61 is subjected to press working (punching, bending, etc.) using a mold.

As described above, the terminal-equipped wire 10 according to the present embodiment includes: the wire 11 having the core wire 21, and the insulator covering portion 22 that covers the core wire 21 with a part of the core wire 21 exposed; and the terminal 12 having the wire connection portion 32 to which the core wire 21 of the wire 11 is bonded. The concave serration 40 extending along the width direction of the terminal 12 is formed on the conductor bonding surface 35 of the wire connection portion 32, and the core wire 21 and the terminal 12 are bonded to each other by method of ultrasonic bonding in a state in which the core wire 21 is in contact with the serration 40. Thereafter, the bonding mark 90 with which the convex portion 80 of the horn 61 of the ultrasonic bonding machine was in contact is formed on the side of the core wire 21 opposite to the side bonded to the terminal 12, and the center of the serration 40 and the center of the bonding mark 90 are arranged so as to be aligned on the straight line La parallel to the height direction of the core wire 21.

In the terminal-equipped wire described above, the serration 40 extending along the width direction of the terminal 12 is formed on the conductor bonding surface 35 of the wire connection portion 32 to which the core wire 21 of the wire 11 is bonded. In addition, at the time of ultrasonic bonding, the serration 40 of the conductor bonding surface 35 and the convex portion 80 of the horn 61 of the ultrasonic bonding machine are arranged so as to be aligned on the straight line La parallel to the height direction of the core wire 21. For this reason, the portion of the core wire 21 that is locally pressed in the vertical downward direction by the convex portion 80 of the horn 61 reaches the inner side of the serration 40 of the wire connection portion 32, thereby increasing the area where the core wire 21 comes into contact with the wire connection portion 32. Therefore, the terminal-equipped wire 10 of the present embodiment makes it possible to provide a terminal-equipped wire in which a bonding strength between a terminal and an electric core wire is improved by increasing an area where the electric core wire comes into contact with the terminal.

### [Bonding Method of Terminal-Equipped Wire]

Next, a bonding method of the terminal-equipped wire 10 according to the present embodiment will be described. The bonding method of the terminal-equipped wire 10 is the method in which the wire 11 having the core wire 21 and the insulator covering portion 22 covering the core wire 21 with a part of the core wire 21 exposed, and the terminal 12 having the wire connection portion 32 to which the core wire 21 of the wire 11 is bonded are bonded by method of ultrasonic bonding.

In the bonding method of the terminal-equipped wire 10, the terminal 12, and the core wire 21 of the wire 11 are clamped by the horn 61 and the anvil 71 of the ultrasonic bonding machine and bonded to each other by method of ultrasonic bonding. The concave serration 40 extending along the width direction of the terminal 12 is formed on the conductor bonding surface 35 of the wire connection portion 32 of the terminal 12. Meanwhile, the convex portion 80 extending along the width direction of the terminal 12 is formed in the horn 61 of the ultrasonic bonding machine.

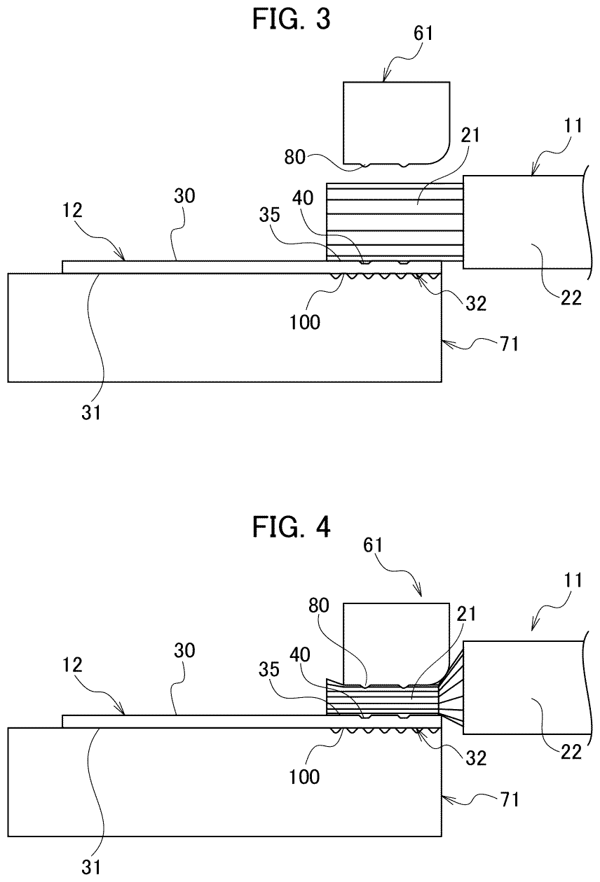

In the bonding method of the terminal-equipped wire 10 according to the present embodiment, first, the terminal 12, and the core wire 21 of the wire 11 are arranged in the ultrasonic bonding machine provided with the horn 61 and the anvil 71. Specifically, as illustrated in FIG. 3, the bonding method of the terminal-equipped wire 10 has a step of arranging the terminal 12 on the upper part of the anvil 71 of the ultrasonic bonding machine, and then arranging the core wire 21 on the upper part of the wire connection portion 32 (conductor bonding surface 35) of the terminal 12. Next, as illustrated in FIGS. 4 and 5, the bonding method of the terminal-equipped wire 10 has a step of arranging the center of the serration 40 of the wire connection portion 32 and the center of the convex portion 80 of the horn 61 so as to be aligned on the straight line La parallel to the height direction of the core wire 21. Both sides of the terminal 12 in the width direction may be held by using a terminal holder (not illustrated).

Further, the bonding method of the terminal-equipped wire 10 has a step of bringing the horn 61 into contact with the core wire 21, pressurizing and vibrating the horn 61 in the vertical downward direction in a state in which the core wire 21 is in contact with each of the serration 40 and the convex portion 80, and bonding the core wire 21 and the terminal 12 by method of ultrasonic bonding.

The horn 61 of the ultrasonic bonding machine is provided with a vibrator (not illustrated) which oscillates ultrasonic vibration by supplying an AC current, and is vibrated by the vibrator. The terminal 12 and the core wire 21 arranged on the upper part of the anvil 71 and arranged between the horn 61 and the anvil 71 are clamped by the horn 61 and the anvil 71 by a load from the horn 61.

After the terminal 12 and the core wire 21 are arranged between the horn 61 and the anvil 71, the horn 61 is caused to move toward the anvil 71. Thus, the terminal 12 and the core wire 21 are held in a pressurized state by the horn 61 and the anvil 71. In this state, an AC current is supplied to the vibrator. Then, since the horn 61 is subjected to ultrasonic vibration in the horizontal direction by the vibrator, ultrasonic vibration energy is propagated to the terminal 12 and the core wire 21, and the core wire 21 of the wire 11 is ultrasonically bonded to the conductor bonding surface 35 of the terminal 12. This makes it possible to obtain the terminal-equipped wire 10 in which the wire 11 is connected to the terminal 12.

In the present embodiment, as described above, at the time of ultrasonic bonding, the center of the serration 40 of the conductor bonding surface 35 and the center of the convex portion 80 of the horn 61 of the ultrasonic bonding machine are arranged so as to be aligned on the straight line La parallel to the height direction of the core wire 21. For this reason, at the time of ultrasonic bonding, the portion of the core wire 21 that is locally pressed in the vertical downward direction by the convex portion 80 of the horn 61 is pushed more strongly to the wire connection portion 32 than the other portions of the core wire 21, and plastically flows, thereby reaching the inner side of the serration 40 of the wire connection portion 32. This makes it possible to increase the area where the core wire 21 comes into contact with the wire connection portion 32 as compared to the shape without the serration 40. Therefore, it is possible to provide the bonding method of the terminal-equipped wire 10 in which the bonding strength between the terminal 12 and the core wire 21 is improved.

After ultrasonic bonding, the bonding mark 90 with which the convex portion 80 of the horn 61 was in contact is formed on the side of the core wire 21 opposite to the side bonded to the terminal 12, and the center of the serration 40 and the center of the bonding mark 90 are arranged so as to be aligned on the straight line La parallel to the height direction of the core wire 21.

Further, in the bonding method of the terminal-equipped wire 10, as described above, it is preferable that the serration 40 extends over the entire width direction of the terminal 12 in the conductor bonding surface 35.

Further, in the bonding method of the terminal-equipped wire 10, as illustrated in FIGS. 3 to 5, it is preferable that the anvil 71 has a projection 100 on the surface that comes into contact with the terminal 12. Since the anvil 71 has the projection 100, it is possible to fix the terminal 12 so as not to move from the anvil 71 due to vibration at the time of ultrasonic bonding.

As described above, the bonding method of the terminal-equipped wire 10 according to the present embodiment is the method in which the wire 11 having the core wire 21 and the insulator covering portion 22 covering the core wire 21 with a part of the core wire 21 exposed, and the terminal 12 having the wire connection portion 32 to which the core wire 21 of the wire 11 is bonded are bonded by method of ultrasonic bonding. Then, the bonding method of the terminal-equipped wire 10 is the method in which the wire 11 and the terminal 12 are clamped by the horn 61 and the anvil 71 of the ultrasonic bonding machine and bonded to each other by method of ultrasonic bonding. The concave serration 40 extending along the width direction of the terminal 12 is formed on the conductor bonding surface 35 of the wire connection portion 32, and the convex portion 80 extending along the width direction of the terminal 12 is formed in the horn 61. The bonding method has a step of arranging the core wire 21 on the upper part of the wire connection portion 32 of the terminal 12 after arranging the terminal 12 on the upper part of the anvil 71. The bonding method has a step of arranging the center of the serration 40 and the center of the convex portion 80 so as to be aligned on the straight line La parallel to the height direction of the core wire 21. The bonding method has a step of bringing the horn 61 into contact with the core wire 21, pressurizing and vibrating the horn 61 in the vertical downward direction in a state in which the core wire 21 is in contact with each of the serration 40 and the convex portion 80, and bonding the core wire 21 and the terminal 12 by method of ultrasonic bonding. After ultrasonic bonding, the bonding mark 90 with which the convex portion 80 of the horn 61 was in contact is formed on the side of the core wire 21 opposite to the side bonded to the terminal 12, and the center of the serration 40 and the center of the bonding mark 90 are arranged so as to be aligned on the straight line La parallel to the height direction of the core wire 21.

In the bonding method of the terminal-equipped wire 10 described above, the serration 40 extending along the width direction of the terminal 12 is formed on the conductor bonding surface 35 of the wire connection portion 32 to which the core wire 21 of the wire 11 is bonded. In addition, at the time of ultrasonic bonding, the serration 40 of the conductor bonding surface 35 and the convex portion 80 of the horn 61 of the ultrasonic bonding machine are arranged so as to be aligned on the straight line La parallel to the height direction of the core wire 21. For this reason, the portion of the core wire 21 that is locally pressed in the vertical downward direction by the convex portion 80 of the horn 61 reaches the inner side of the serration 40 of the wire connection portion 32, thereby increasing the area where the core wire 21 comes into contact with the wire connection portion 32. Therefore, it is possible to provide the bonding method of the terminal-equipped wire 10 in which the bonding strength between the terminal 12 and the core wire 21 is improved.

As described above, the bonding method of the terminal-equipped wire 10 makes it possible to provide a terminal-equipped wire in which a bonding strength between a terminal and an electric core wire is improved by increasing an area where the electric core wire comes into contact with the terminal.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A terminal-equipped wire, comprising:
a wire having a core wire, and an insulator covering portion that covers the core wire with a part of the core wire exposed; and
a terminal having a wire connection portion to which the core wire of the wire is bonded, wherein
a concave serration extending along a width direction of the terminal is formed on a conductor bonding surface of the wire connection portion,
the core wire and the terminal are bonded to each other by method of ultrasonic bonding in a state in which the core wire is in contact with the serration,
a bonding mark with which a convex portion of a horn of an ultrasonic bonding machine was in contact is formed on a side of the core wire opposite to a side bonded to the terminal, and
a center of the serration and a center of the bonding mark are arranged so as to be aligned on a straight line parallel to a height direction of the core wire.

2. The terminal-equipped wire according to claim 1,
wherein the serration extends over an entire width direction of the terminal in the conductor bonding surface.

3. A bonding method of a terminal-equipped wire in which a wire having a core wire and an insulator covering portion covering the core wire with a part of the core wire exposed, and a terminal having a wire connection portion to which the core wire of the wire is bonded are clamped by a horn and an anvil of an ultrasonic bonding machine and bonded to each other by method of ultrasonic bonding, wherein
a concave serration extending along a width direction of the terminal is formed on a conductor bonding surface of the wire connection portion, and
a convex portion extending along a width direction of the terminal is formed in the horn, the bonding method comprises:
a step of arranging the core wire on an upper part of the wire connection portion of the terminal after arranging the terminal on an upper part of the anvil;
a step of arranging a center of the serration and a center of the convex portion so as to be aligned on a straight line parallel to a height direction of the core wire; and
a step of bringing the horn into contact with the core wire, pressurizing and vibrating the horn in a vertical downward direction in a state in which the core wire is in contact with each of the serration and the convex portion, and bonding the core wire and the terminal by method of ultrasonic bonding,
after ultrasonic bonding, a bonding mark with which the convex portion of the horn was in contact is formed on a side of the core wire opposite to a side bonded to the terminal, and
a center of the serration and a center of the bonding mark are arranged so as to be aligned on a straight line parallel to a height direction of the core wire.

4. The bonding method of the terminal-equipped wire according to claim 3,
wherein the serration extends over an entire width direction of the terminal in the conductor bonding surface.

5. The bonding method of the terminal-equipped wire according to claim 3,
wherein the anvil has a projection on a surface that comes into contact with the terminal.
